(19) United States
(12) Patent Application Publication
(10) Pub. No.: US 2004/0170823 A1
(43) Pub. Date: Sep. 2, 2004

(54) Flat body comprising a scratch protection layer

(76) Inventors: Bernd Schultheis, Schwabenheim (DE); Cora Krause, Burnweiler (DE)

Correspondence Address: Striker Striker & Stenby, 103 East Neck Road, Huntington, NY, 11743, US

(21) Appl. No.: 10/483,306

(22) PCT Filed: Jul. 9, 2002
(86) PCT No.: PCT/EP02/07599

(30) Foreign Application Priority Data
Jun. 10, 2001 (DE) 101 22 478.8

(51) Int. Cl. B32B 9/00; B32B 17/06

(52) U.S. Cl. 428/325; 428/432; 428/702

(57) ABSTRACT

The invention relates to a flat bodies, for example glass plates or glass ceramic plates (1), which are used as cooking surfaces for modern cooking hobs. Said flat bodies require an adapted scratch protection layer, in order to avoid marks caused by use. To this end, the use of mechanically resistant material particles for scratch protection is known. According to the invention, an especially effective scratch protection layer can be obtained when it is formed by very fine mechanically resistant material particles (3) which are randomly and finely distributed, and partially embedded, in the surface of the body (1), in order to form a structured surface. Said mechanically resistant material particles (3) are preferably embedded in an intermediate layer (2).

The present invention relates to a flat body provided with a scratch protection layer composed of hard materials, in particular on an optically transparent body such as glass or glass ceramic.

In particular, the present invention relates to a glass ceramic plate, which is used as a cooking surface for a cooking hob, and which has a protection layer on its upper side, which said protection layer has greater scratch resistance than glass ceramic.

Modern cooking hobs have a glass ceramic plate as a cooking surface, whereby the glass ceramic plate is typically flat, although it can also have a two or three-dimensional shape. Glass ceramic plates are made known in printed literature and/or they are on the market; they are undecorated or decorated with temperature-resistant colors, e.g., ceramic colors. The cooking surface has individual cooking zones that are heated via induction, or with electric halogen heating elements, or with gas-radiant heating elements.

Glass ceramic plates typically have a Mohs hardness of 5-6. Said hardness is comparable to steel, which is typically used to fabricate cooking utensils. When the cooking utensil is moved, or when the cooking surfaces are cleaned with abrasive cleansers and sponges, etc., in daily use, the cooking surface is therefore subjected to high mechanical stress, which results in marks caused by use, i.e., a certain level of noticeability of scratches.

Glass ceramic plates from the previous generation typically had a surface structure similar to that of an orange peel, which ensured a relatively low level of noticeability of scratches. The surfaces of glass ceramic plates have become smoother and shinier over time, however, which results in an increased noticeability of scratches for the reasons stated hereinabove.

Cooking hobs with a glass ceramic plate as the cooking surface are also known which are decorated on the upper side with ceramic colors (DE 44 26 234 C1; DE 197 28 881 C1). Although said ceramic colors reduce the noticeability of marks caused by pans moving across the surface and cleaning, the decorative layer itself is also subjected to the mechanical stress described hereinabove in daily use. As a result, said decorative layer also shows marks caused by use over the course of time, and it becomes increasingly unattractive as it wears off. In addition, designs call for the ceramic colors to cover increasingly less surface area. Often, a decorative design is limited to marking a cooking zone and company logos. The largest part of the cooking surfaces therefore remains undecorated, so that a very large exposed area composed only of glass ceramic remains, which is therefore subjected directly to mechanical stress caused by pans moving across it, cleaning, etc.

Publication EP 0 231 529 B1 solves the problem of high susceptibility to scratching, the noticeability of scratches on the upper side of the cooking surface, and the rubbing off of the decorative colors applied to the cooking surface by the fact that certain randomly distributed surface areas of the glass ceramic cooking surface are raised relative to their surroundings. Therefore, only the raised areas are essentially subject to wear.

Publication EP 0 716 270 B1 describes a cooking surface composed of glass ceramic, with a pattern printed on the surface having a protection layer to prevent scratches or markings caused by use; said protection layer is formed by an enamel-flux or silicate coating with greater scratch resistance than the glass ceramic. Said protection layer seals the glass ceramic cooking surface to the greatest extent possible, and a pattern is printed on said protection layer or directly on the glass ceramic surface. The protection layer is preferably made of a dark material. Although said protection layer basically increases the mechanically stressability of the glass ceramic cooking surfaces, so that the cooking surface is less susceptible to scratching during use than an unprotected cooking surface, the enamel-flux or silicate protective coatings alone disclosed in the EP publication do not provide optimum mechanical protection over the long term.

A disadvantage is that the protection layer itself is a decoration that is applied by screen printing. As a rule, said decorative colorants are based on the same fluxes as the decorative colorants used for the optical design. They are therefore subject to the same restrictions with regard for rubbing off. The minimum size of decorations of this type is in the magnitude of 0.5 mm, which is optically perceptible and therefore disruptive to the design, especially when optically transparent glasses or glass ceramics are desired.

In the earlier, non-published patent application DE 100 00 663.9, a method and the associated device are described with which an optically transparent body is provided with a scratch protection layer composed of Al₂O₃ that is applied using PICVD technology over the entire surface in such a manner that a hard material layer forms.

The high level of procedural complexity is a disadvantage, particularly when coatings having a large surface area must be applied homogeneously. Inhomogeneities have been unavoidable until now, and they permanently impair the optical appearance.

Furthermore, publication WO 96/31995 describes an inductively heated glass or glass ceramic cooking surface with integrated coils, on which a hard material layer composed of Al₂O₃ is applied using the technique of plasma spraying in a layer thickness of between 50 and 200 μm.

The disadvantage of this is that thick layers of this type are very coarse, which has a negative effect on use-related properties, such as wear caused by pans or hands moving across the surface, and the cleaning behavior. In addition, the appearance of the cooking surfaces changes completely when a layer such as this is used.

Other optically transparent, flat bodies composed of glass, glass ceramic or plastic have similar scratch protection problems.

The present invention is based on the object of providing a highly-effective scratch protection layer for a flat body, which is optically practically imperceptible, but that is capable of being applied as a matt, uniform surface, over large areas, and in an economical manner.

This object is attained according to the invention using a flat body with a scratch protection layer composed of hard materials, which said layer is formed by very fine mechanically resistant material particles that are <5 μm in size, which are randomly and finely distributed, and partially embedded, in the surface of the body, in order to form a structured surface.

The scratch protection layer according to the invention is therefore not a sealed, uniform layer in itself. Instead, the mechanically resistant material particles, since they are not fully embedded, form a type of “rubble field” on the surface of the body. Since said mechanically resistant material particles are embedded practically individually in the surface of the body, the scratch protection layer adheres well to the body, making it highly effective, especially since only the projecting, mechanically resistant material particles come in direct contact with the scratching object. The random, fine distribution of the very fine mechanically resistant material particles ensures that the scratch protection layer is practically optically imperceptible, and then only as a matt, uniform surface.

Publication DE 38 44 522 C2 describes a method for coating cooking utensils with a ceramic hard material layer that is thoroughly sealed with lacquers to prevent grease from penetrating and staining the undersurface. The mechanically resistant material particles, which have a grain size between 5 μm and 20 μm, are therefore completely embedded, i.e., on all sides, in the hard material/lacquer layer, so that the lacquer surfaces are directly exposed to a scratching object; the optical appearance of said lacquer surfaces can therefore change and/or sustain strong wear. A “rubble field” of mechanically resistant material particles <5 μm in size as is the case with the invention therefore does not apply here.

Publication DE 196 29 241 relates to a method for producing a non-slip surface on a glass pane for in-ground light fixtures to prevent pedestrians from slipping on the glass pane. To this end, the glass pane is provided with a carrier layer in which hard particles are inserted. Said particles necessarily have a very coarse grit size, typically 280-300 μm, to enable the non-slip effect. A coarse grit size of this type would not be usable for a scratch protection layer as such, because it would greatly impair the optical appearance of the body.

Said change in the optical properties caused by relatively large particles is specifically utilized, in fact, with a light-diffusing translucent building component in the case of DE 23 14 622 B2, by providing the building component with a coating that contains a granular material composed of small beads preferably having a diameter in the range of 90 to 270 μm. Said granular material enhances the light-diffusing effect in the desired manner.

Publication DE 100 40 013 A1 relates to a deep-drawn bathroom fitting composed of plastic, which has a scratch-resistant coating on the usable surface, which said coating contains uniformly distributed, anorganic, hard material particles having a size in the nanometer range (0.01-0.11 μm). In the known case, the hard material particles are fully embedded in the associated coating, which is preferably a lacquer-like coating. Said particles are held in a binding-agent matrix and do not affect the shiny appearance. The main feature according to the invention, namely that the hard material particles are only partially embedded in the scratch protection layer in the manner of a “rubble field”, in order to form the sole contact surface with scratching objects, is neither described in the publication mentioned hereinabove, nor are any statements made in this direction.

The “packing density” of the hard material particles determines the extent of coverage of the body surface. Depending on the application of the body, the arrangement can be selected so that the scratch protection layer is configured as a partial layer that covers <100%, and preferably <50%, of the surface of the body; as an alternative, said scratch protection layer may be configured with an extent of coverage of nearly 100% over nearly the entire surface.

A particularly effective scratch protection layer may be obtained according to a further development of the invention when the mechanically resistant material particles are ceramic particles composed of oxide or non-oxide ceramic, whereby the ceramic is preferably composed of aluminum oxide, boron nitride, zircon oxide, or silicon nitride.

The particle size, i.e., the grit size, has a decisive influence on the effectiveness of the scratch protection layer and its optical perceptibility. The particle size distribution is defined using D values. For instance, D₅₀ means that 50% of all particles have the particular stated grit size, and D₉₀ means that 90% of all particles have the stated grit size. It is advantageous when, according to an embodiment of the invention, the D₉₀ particle size is <5 μm, and typically <1 μm, and the D₅₀ particle size is typically 0.1 to 2 μm.

As an alternative, the mechanically resistant material particles can also be composed of splats, i.e., lenticular partciles with a typical diameter of 10 to 50 μm, and a thickness of typically 1 to 5 μm.

The mechanically resistant material particles can be embedded directly in the surface of the body, or, as an alternative, in an intermediate layer that has been applied to the surface of the body and that is relatively low-melting compared to the body material, therefore permitting lower process times for preheating and/or lower energies when using thermal spraying processes for embedding. The reduction in process temperature and improvement in adhesion is enhanced when the intermediate layer is composed of siliceous material, preferably SiO₂, and the siliceous intermediate layer is doped with an alkali and/or boron and/or fluorine.

In addition, the thermal expansion of the body material can be made similar to that of the ceramic article by means of said intermediate layer, which can also be formed by a plurality of individual layers.

A particularly favorable effect of the intermediate layer is given when the thickness of the intermediate layer is <10 μm, and typically in the range of 0.2 to 0.5 μm.

In order to provide color, pigments can be advantageously mixed with the mechanically resistant material particles, or the mechanically resistant material particles themselves can be coloring particles, such as Co/Ni/Fe/Cr spinel (black), Zn/Cr/Fe spinel (brown), zircons, rutiles, perowskite, etc.

The mechanically resistant material particles may be embedded particularly well according to a further development of the invention when said mechanically resistant material particles are embedded in a thermal spraying process, such as plasma or flame spraying.

With this method, the mechanically resistant material particles are plasticized and accelerated with high kinetic energy. The particles cool upon impact and partially penetrate the surface of the body or the intermediate layer. Said particles thereby become splats. Depending on the temperature-dependent viscosity behavior of the surface of the body or the intermediate layer, this process is supported by preheating the body with the intermediate layer, if necessary, preferably to form a glass body, to a temperature below Tg (glass transition temperature), so that good adhesion is ensured.

It is also feasible, in principle, to embed the mechanically resistant material particles out of a suspension via sedimentation.

A scratch protection layer having very long life can be obtained when, according to an embodiment of the invention, the mechanically resistant material particles are introduced via baking or sintering.

The body equipped with the scratch protection layer is preferably a vitreous body, e.g., a float glass pane composed of soda-lime glass, borosilicate glass or aluminosilicate glass, or it is a ceramicized glass body, preferably a glass ceramic plate, which is used as a cooking surface for a cooking hob. The body can also be composed of a plastic such as PMMA or polycarbonate, for example.

The invention will be described in greater detail with reference to the embodiments presented in the drawing.

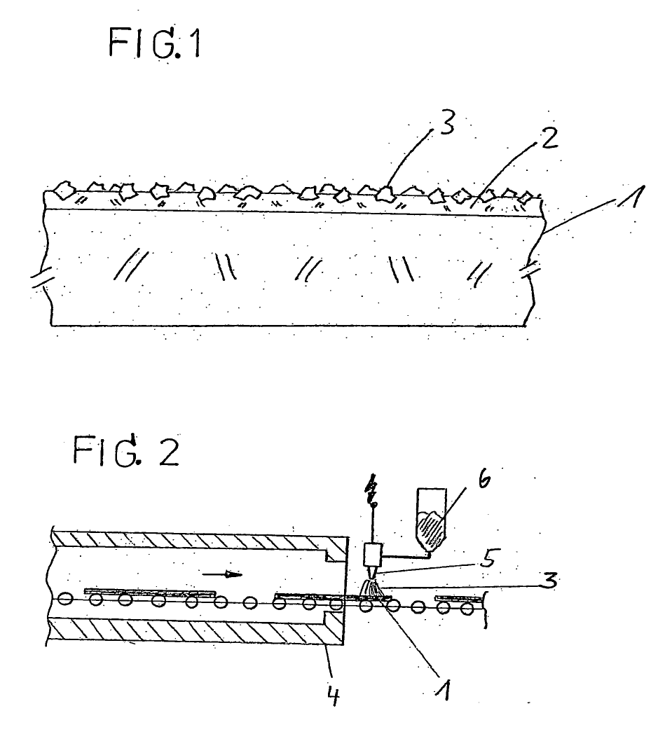

FIG. 1 is a schematic side view of a section of a glass ceramic cooking surface to which a scratch protection layer according to the invention has been applied, and

FIG. 2 is a preferred device for applying the scratch protection layer to the cooking surface according to FIG. 1.

FIG. 1 shows a section of an exemplary embodiment of an optically transparent body, according to the invention, in the form of a glass ceramic plate 1 that is used as a cooking surface. An intermediate layer 2 composed of flux which contains boron is applied to glass ceramic plate 1, in which said intermediate layer superfine, mechanically resistant material particles 3, preferably ceramic particles, are partially deposited, in order to form a scratch protection layer in the manner of a “rubble field”. Mechanically resistant material particles 3 are typically <1 μm in size, so they are not optically perceptible. The extent of coverage of the surface is <50% in the exemplary embodiment.

FIG. 2 is a schematic representation of a preferred embodiment for producing glass ceramic plate 1 according to FIG. 1, which is equipped with a scratch protection layer composed of mechanically resistant material particles.

In a conventional ceramicization furnace 4, a green glass plate is transformed into a glass ceramic plate 1 in the usual manner. The temperature of glass ceramic plate 1 at the outlet of ceramicization furnace 4 is still 600°-700° C. At least one plasma spray gun 5 is located at the furnace outlet, which said spray gun applies mechanically resistant material particles 3 from a reservoir 6 to the surface—which is still hot and, therefore, soft—so that mechanically resistant material particles 3 partially penetrate intermediate layer 2—as shown in the representation in FIG. 1—and adhere there.

In order to ensure homogeneous application of the mechanically resistant material particles, plasma spray gun 5 is preferably capable of pivoting.

The mechanically resistant material particles can also be sprayed on after the hot-forming of the green glass to be ceramicized.

In the production of tempered sheet glass, the spraying-on takes place advantageously directly after the tempering furnace or, as an alternative, during the float process.

The scratch protection layer can be applied before or after decorating. In the latter case, the decoration is protected as well.

Optically transparent bodies provided with a scratch protection layer according to the invention can be, in particular:

Glass ceramic cooking surfaces

Tempered soda-lime glass, e.g., control panels, oven windows

Glass utensils (glass baking dish, microwave dishes, glass cutting boards, etc.)

Glass ceramic fireplace windows

Oven windows composed of glass ceramic, in particular for pyrolysis ovens

Glass tables

Glass countertops

Glasses for automotive headlamps

and other glass, glass ceramic or plastic surfaces which are subjected to mechanical stress.

What is claimed is:

1. Flat body comprising a scratch protection layer made from hard materials, which is formed by very fine mechanically resistant material particles (3) that are <5 μm in size, which are randomly and finely distributed, and partially embedded, in the surface of the body (1), in order to form a structured surface.

2. The body as recited in claim 1,
wherein the scratch protection layer is configured as a partial layer that covers <100%, and preferably <50%, of the surface of the body.

3. The body as recited in claim 1,
wherein the scratch protection layer is configured with an extent of coverage of nearly 100% over nearly the entire surface.

4. The body as recited in claim 1, or 2, 3,
wherein the mechanically resistant are ceramic particles composed of oxide or non-oxide ceramic.

5. The body as recited in claim 4,
wherein the ceramic is composed of aluminum oxide, boron nitride, zircon oxide, or silicon nitride.

6. The body as recited in one of the claims 1 through 5,
wherein the particle size, in combination with the particle size distribution, is D₉₀<5 μm, and typically <1 μm, and D₅₀ is typically 0.1 to 2 μm.

7. The body as recited in one of the claims 1 through 5,
wherein the mechanically resistant material particles are composed of splats with a typical diameter of 10 to 50 μm, and a thickness of only a few μm, preferably 1 to 5 μm.

8. The body as recited in one of the claims 1 through 7,
wherein the very fine, mechanically resistant material particles are embedded directly in the surface of the body.

9. The body as recited in one of the claims 1 through 7,
wherein the very fine, mechanically resistant material particles are embedded in at least one intermediate layer applied to the surface of the body.

10. The body as recited in claim 9,
wherein the intermediate layer is composed of siliceous material, preferably SiO₂.

11. The body as recited in claim 10,
wherein the siliceous intermediate layer is doped with an alkali and/or boron and/or fluorine.

12. The body as recited in one of the claims 9 through 11,
wherein the thickness of the intermediate layer is <10 μm, and typically in the range of 0.2-0.5 μm.

13. The body as recited in one of the claims 1 through 12,
wherein pigments are mixed with the mechanically resistant material particles.

14. The body as recited in one of the claims 1 through 12,
wherein the mechanically resistant material particles themselves are coloring pigments.

15. The body as recited in one of the claims 1 through 14,
wherein the mechanically resistant material particles are embedded in a thermal spraying process, such as plasma or flame spraying.

16. The body as recited in one of the claims 1 through 14,
wherein the mechanically resistant material particles are embedded during deposition of a suspension.

17. The body as recited in one of the claims 1 through 16,
wherein the mechanically resistant material particles are introduced via baking or sintering.

18. The body as recited in one of the claims 1 through 17,
wherein it is composed of glass or glass ceramic.

19. The body as recited in claim 17,
wherein it is configured as a glass/glass ceramic cooking surface or a glass/glass ceramic fireplace pane.

20. The body as recited in one of the claims 1 through 18,
wherein it is configured as a float glass pane composed of soda-lime glass, borosilicate glass or aluminosilicate glass.

21. The body as recited in one of the claims 1 through 17,
wherein it is composed of a plastic such as PMMA or polycarbonate.
